(19) United States
(12) Patent Application Publication
(10) Pub. No.: US 2005/0152616 A1
(43) Pub. Date: Jul. 14, 2005

(54) Method and apparatus for automatic scanner defect detection

(76) Inventor: James R. Bailey, Shelbyville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/754,123

(22) Filed: Jan. 9, 2004

(51) Int. Cl. G06K 9/40

(52) U.S. Cl. 382/275

(57) ABSTRACT

Defects are automatically detected in an image scanning device by performing a defect calibration scan of an image scanning area and detecting at least one defect in at least one section of the image scanning area. A tag is generated for the section of the image scanning area in which the defect is detected. The defect is compensated for in the scanned image based on information contained within the tag.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING ETC.

None.

### BACKGROUND

1. Field of the Invention

The present invention is directed to a method and apparatus for detecting for defects in an image forming device. More particularly, this invention is directed to a method and apparatus for automatically detecting defects in an image scanner.

2. Description of the Related Art

When scanning an image using a host-based scanner or multi-functional device, such as an all-in-one (AIO) scanner/copier/printer, it is often desirable to perform certain image processing tasks to enhance the output image as well as to remove the imperfections introduced into the image by the device. For example, scanned image artifacts, such as Moire patterns, can be removed using image filtering techniques like de-screening filters. Smoothing filters can help soften the effect of noise that is injected into the scanned image during the scanning operation.

Image content detection algorithms are often applied to detect various regions of the image, e.g., regions including text and photo data. This content detection, in turn, determines what type of image processing tasks are performed on those regions. Such image processing tasks play a critical role in the quality of the scanned or copied image. The quality of the scanned/copied image is a major contributor to the perceived quality of the entire device.

Over time, scanners often suffer from physical defects, such as scratches on the scanner platen glass, settled debris, such as lint and dust, smudges on the scanner lid, and various other physical defects that lead to an overall degradation in the scanned output quality. Not only are such defects always scanned into the image, but the defects themselves may cause unwanted effects on the image processing algorithms used to improve the scanned output or minimize the scan/copy time.

As an illustrative example, consider how a scratch on a scanner glass affects operation of an autofit algorithm in a typical scanner. An autofit algorithm is typically applied to a scanned target image to enlarge the image to fit the page. To apply the autofit algorithm, the borders of the target image must be found. This is typically done by performing a low resolution scan across the scanner glass with the target image on the glass and the scanner lid down. The low resolution scan detects non-white space, i.e., space that does not appear to be the scanner lid. The borders of the detected non-white space are considered to be the borders of the target image. Once the borders of the target image are found in this manner, a high-resolution scan is performed on the target image, and the scanned target image is then enlarged to fit the page.

Performing a low resolution prescan to find the target image borders first and then conducting a high resolution scan based on the detected borders saves memory and processing time. However, the time/memory saved and the quality of the output are only as good as the prescan is at finding the borders of the target image. If there is a defect, e.g., a scratch on the scanner glass, traditional auto-fit algorithms will detect the scratch as part of the target, since the scratch will appear as non-white space. The scratch will then be processed, along with the target image. Thus, more data than necessary will be scanned and processed, requiring a much longer overall scan and copy time than necessary. Also, the actual target image will not be enlarged to fit the page, as the areas included because of the defects erroneously included in the image will consume part of the output page. Over time, the auto-fit function may get slower and less accurate.

Physical defects also affect image filtering techniques. It is often desirable to sharpen edges to improve the visual contrast of the edge of an image. A dark piece of dust will often be detected as an edge and thus amplified by image filtering techniques, making it even more visible to the user. Dust may also prevent the detection of whitespace regions, thereby causing a lot of unnecessary data to be processed by the scanner.

Without some means of defect detection and compensation, the user's experience may become more negative as the scanner ages. The means used to detect physical defects must not require much, if any, user interaction. Requiring such tasks often confuses the user and makes the scanner less usable. The ideal scanner would contain a way to intelligently detect and compensate for physical defects without the user's knowledge. Such smart scanning tasks would ideally improve the reliability and robustness of the product without affecting the usability.

### SUMMARY

According to an exemplary embodiment, a method and apparatus are provided for automatically detecting defects in an image scanning device. A defect calibration scan of an image scanning area is performed. If at least one defect in at least one section of the image scanning area is detected a tag is generated for the section of the image scanning area in which the defect is detected. The defect is compensated for based on information contained within the tag.

### BRIEF DESCRIPTION OF THE DRAWINGS

The accompanying drawings illustrate exemplary embodiments, and together with the description, serve to explain the exemplary principles of the invention.

FIG. 1A illustrates an exemplary two-dimensional map of sections of an image scanning area;

FIG. 1B illustrates an exemplary defect that spans sections of an image scanning area;

FIG. 2A illustrates how a target image would be conventionally detected including the defect;

FIG. 2B illustrates how a target image is detected according to an exemplary embodiment;

FIG. 3A illustrates an exemplary method for detecting defects in an image scanning area according to exemplary embodiments;

FIG. 3B illustrates in detail exemplary steps of a method for detecting defects in an image scanning area according to an exemplary embodiment; and

FIG. 4 illustrates an exemplary implementation of the invention.

### DETAILED DESCRIPTION

According to an exemplary embodiment, a technique is provided for detecting defects in an image forming device, such as a scanner, automatically and without user intervention. The results of the detection may be stored and used for future analysis and defect compensation techniques.

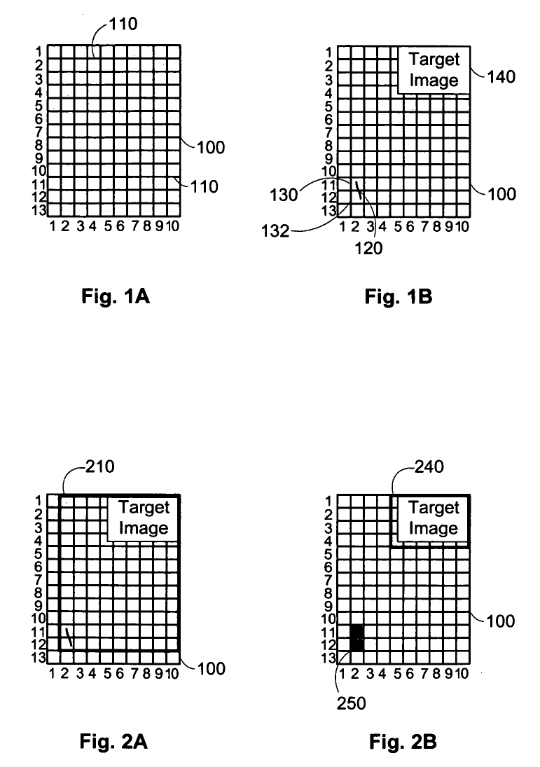

In an exemplary embodiment, a two-dimensional map or array may be used to represent sections of the image scanning area 100, e.g., the scanner glass, as shown in FIG. 1A. Each section 110 of the image scanning area 100 is denoted by its grid location and is comprised of an n=m array of pixels or data elements. For example, the top left section at the corner of the scan area is denoted as (1,1). Each section of the image scanning area is represented by a “defect tag” which is stored in a memory, such as a hard disk drive on a PC or non-volatile RAM (NVRAM) on a scanner controller printed circuit board (PCB). The smaller the resolution of the two-dimensional map, the larger the number of defect tags that exist and need to be stored.

Each defect tag contains information representing the result of defect detection performed for the associated section of the image scanning area. For example, the defect tag may indicate that a permanent defect, such as a scratch on the scanner glass, has been detected in a section of the image scanning area. Alternatively, the tag may indicate that a potential defect has been detected in a section of the image scanning area but that the defect may not be permanent. Other pieces of information may be stored in the tag as well. The goal is to be able to quickly identify problematic regions of the image scanning area so that image processing tasks can adjust for the defect. In general assuming that a white reference plane or background is being used in the scanner, sections of the image scanning area not containing a defect are comprised of white space.

Tagging image scanning area sections as having defects may be useful in specialty modes, such as auto fit, clone, and poster. These specialty modes utilize a pre-scan to find the image borders (top, bottom, left, and right). Defects, such as scratches, may cause these operations to fail.

The auto-fit function, also known as fit-to-page, finds the image borders and then upscales the image to fit the entire output page. If the borders are incorrectly found, the resulting image will not fit the entire page, and the operation will have failed.

In the clone mode, the target image is found, scaled, and repeated on a page multiple times. For example, if the target image is 8×10″ and a selection is made to clone the image four times, the image will be downscaled to fit 25% of the output page and repeated four times on that page. Correctly finding the image borders is important in this mode, just-as in the auto-fit mode.

In the poster mode, the target image borders are found, and the target image is upscaled to fit over multiple pages, like pieces of a poster. This operation is similar to autofit except that this operation fits the target image to multiple pages. Finding the target image borders is important in this mode, as in the auto-fit and clone modes.

Defects will cause the task of finding the image borders in any of these specialty modes to fail. According to an exemplary embodiment, these specialty modes may be handled by reading the stored defect tags for each scanned region during the image border finding task and ignoring areas with defects to prevent errors in the operation.

For example, assume a scratch 120 is located in the bottom left hand corner of the scanner glass 100 spanning blocks 130 and 132 at coordinates (11, 2) and (12, 2), as shown in FIG. 1B. If a target image 140 is placed on the opposite corner, and an auto-fit algorithm is used to scan the target image 130, the auto-fit algorithm will detect that the image stretches from coordinates (12, 2) to (1, 10), roughly 82% of the total image scanning area (auto-fit usually finds the square margins of the entire target image; thus for this example, it would find the image to be from the bottom left corner to the top right corner). Drawing the largest rectangle around the detected target, the target image region data would be detected from coordinates (12, 2) to (1, 10) as shown in FIG. 2A within rectangle 210. Thus, the actual target image 130 will only be scaled up a minimal amount and will not be close to the full size of the output page after auto-fit is performed.

However, if the two sections 130, 132 containing the scratch 120, (11, 2) and (12,2) are represented by defect tags which indicate that a defect is present within those sections (as indicated by the shaded box 250 in FIG. 2B), then the auto-fit algorithm can be modified to take the tags into consideration and ignore such sections of the image scanning area 100. Using the defect tags, auto-fit would then detect the target image to be from (5, 4) to (10, 1), roughly 15% of the total scan area, as shown in FIG. 2B in rectangle 240. The target image 140 may be enlarged to fit the page, which is the intended purpose of the auto-fit function. Processing 15% of the image scanning area using this technique will take substantially less time than processing 82% of the scan area, thus using the defect tags will also save on the total copy time. Thus, according to an exemplary embodiment, tagging scan areas as having a defect can be used by auto-fit and white space detection to reduce scan time and better detect the actual image content. This will result in correct operation thus making the product operation adaptable to defects it incurs over time.

Another application of defect tagging can be reducing the effect of the defect when the target image lies on top of the defect itself, i.e., when the section of the image scanning area having a defect is included in a target image region. For example, if an area is known to contain a defect, such as dust or a scratch, then image filtering algorithms can use this information to avoid sharpening such areas to prevent amplifying the problem. Smoothing algorithms, such as a median filter, may be applied on such areas to reduce the visual affect of the defect itself.

If a section of the image scanning area is tagged as having a defect, then recursive analysis may also be performed on that section to characterize the nature of the defect itself. This information can also be stored as part of the defect tag.

For example, assume that sections 130, 132 at coordinates (11, 2) and (12, 2) are tagged to be permanent defects. These sections may then be analyzed in finer resolution to determine the nature of the defect, e.g., to determine whether the defect is light or dark, to determine how much of that section of the image scanning area is affected by the defect, etc. Once the defect is characterized, noise rejection techniques may be applied to reject the defect and use the surrounding pixel information to fill in the rejected space. Thus, the defect may be automatically removed from the scanned output image.

According to an exemplary embodiment, defect detection may be automatically performed during a defect calibration prescan, when a target is not being scanned. The least likely time for a target image to be placed on the scanner glass is at power-up of the scanner. Thus, according to one embodiment, a quick, low resolution defect calibration scan of the scanner lid may be performed at power-up as part of normal calibration. The defect calibration may also be performed at other times, e.g., periodically or upon request by a user.

The defect calibration scan may be performed automatically at various times or may be activated in response to data indicating potential defects. For example, if a substantial amount of data is detected using auto-fit some number of times, indicating that auto-fit is failing because of defects on the scanner glass or lid, the defect calibration scan may be initiated automatically

Since the defect calibration scan is low-resolution, the data from the data from the defect calibration scan may be quickly analyzed without greatly impacting the overall normal scan time.

The data collected from the defect calibration scan may first be analyzed to determine if the scanner lid is down and if there is a target present. This determination may be made by determining the content of the scanned data. For example, if mostly white space is detected in the scanned data, then there is a high probability that just the lid is being scanned. If the defect calibration scan data indicates that the lid is up or that a target present, then the defect analysis may be stopped. If the scanned data indicates that a target is in a particular section of the image scanning area, then the rest of the scan area may be analyzed for defects.

In one embodiment, if non-white space is detected (if the scanner lid is White as it traditionally is) in sections of the image scanning area during the defect calibration scan, then the associated sections are tagged as a potential defect. If, after some number of defect calibration scans, a section remains tagged as having a potential defect, then that section may become tagged as containing a permanent defect, such as a scratch. If a section is tagged as having a potential defect section once, but then a defect is not detected for that section subsequently, then that section may be cleared as a defect section and the defect may be assumed to be floating debris, such as dust or lint.

Other characteristics of the section may be stored with the tag, such as the number of color, gray, and black pixels contained in the defect region. This information may be used by other image processing tasks to compensate for the defect.

By performing periodic, automatic defect calibration scans and storing the results, the defect detection becomes adaptive to help extend the reliability of the product without requiring user intervention. Of course, defect calibration scans may also be initiated responsive to a user action, e.g., by prompting a user to scan the lid for calibration purposes.

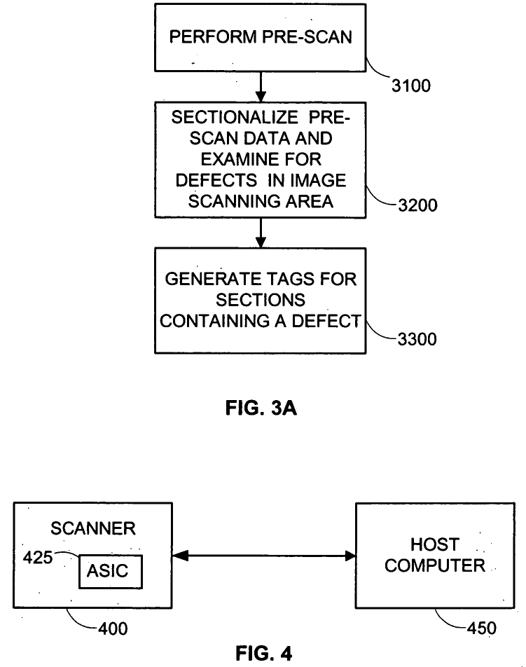

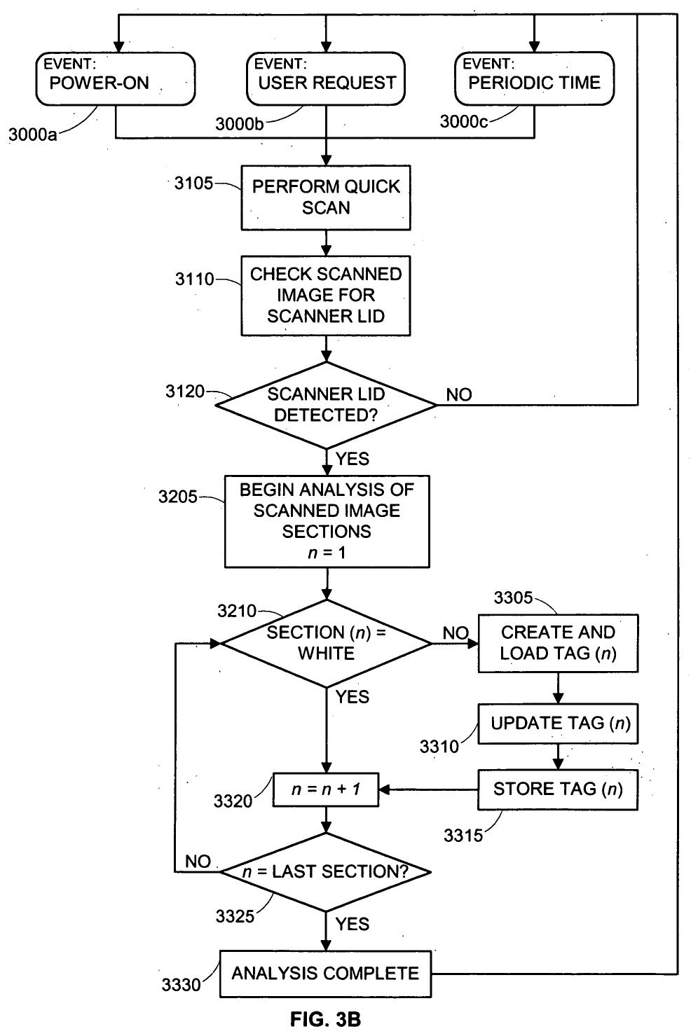

FIG. 3A shows an exemplary method for performing basic defect detection for a scanner. A quick defect calibration “pre-scan” is performed at step 3100, the pre-scan data is sectionalized and examined for defects in the image scanning area at step 3200, and tags are generated for each of the sections containing a detected defect at step 3300. Based on the tags, the defects may be compensated for in the scanned image.

FIG. 3B shows in more detail exemplary steps in a method for automatic defect detection. Upon occurrence of an event, such as power-up 3000a, a user request 3000b, or some other event, such as a periodic timer 3000c, the defect detection task is triggered. A quick scan is performed at step 3105. According to one embodiment, the scanned data is analyzed at step 3110 to determine if the scanner lid was detected as being down. If the scanner lid was not detected as being down at step 3120, the defect detection stops.

If the scanner lid was detected as being down and no target was detected on the scanner glass, then each section of the imaging area is analyzed for non-white areas at step 3205.

For sections that are determined to have non-white areas, tags are created and loaded, updated, and stored at steps 3305, 3310, and 3315, respectively. Once the tag is stored for a section at step 3315 or if a section is determined to have no non-white areas at step 3210, the analysis moves to the next section at step 3320 until the last section is reached at step 3325. Then the analysis is completed at step 3330. Once all sections have been analyzed, the task “sleeps” until the occurrence of another event trigger.

Although not illustrated, additional steps may be taken to recursively sub-divide the sections tagged as having a defect and determine exactly where and/or what the defect is. The information stored in the tag may also be read after a section is determined to be non-white to determine, e.g., whether the defect has been detected before (indicating a permanent defect, such as a scratch), or if the defect is new (indicating a temporary defect such as dust). If the section was determined to only contain white areas, the tag associated with the section may be loaded, and any defect information contained within the tag may be cleared.

It should be appreciated that other events besides the ones listed in FIG. 3B may trigger the defect detection task. The three triggering events listed are just examples. Also, depending on triggering event, the flow of steps may change. For example, if the user requested that the defect detection task be run, then if the scanner lid is not detected at step 3120, the user may be prompted to close the scanner lid.

FIG. 4 illustrates an exemplary apparatus and system for automatic defection detection according to an exemplary embodiment. In FIG. 4, defect detection/compensation is applied in a scanner 400 having traditional scanner components. The scanner may also include an ASIC 425 that receives scanned data and includes memory and a processor for performing the tasks of defect detection and analysis, tag generation and storing, and compensation. The scanner may be a standalone scanner, be part of a multifunction device such as, for example, a printer, scanner, copier, or may be connected to a host computer 450 from which instructions may be sent to the scanner to perform a scan. ASIC 425 may operate independently from the host computer 450 to perform defect detection, tag generation and storing, and compensation. Alternatively, the host computer may obtain scanned data, e.g., prescan data, from the scanner 400 via a software driver and then perform the tasks of defect detection, tag generation and storage, and compensation. As another alternative, the ASIC and the host computer may share the tasks of defect detection, tag generation and storage, and compensation.

According to exemplary embodiments, the automatic defect detection and compensation technique is adaptive and improves the reliability of output quality and performance of the image forming device, despite the introduction of defects into the device over time. By automating a quick defect calibration scan, defects may be detected and associated defect tags can be stored for the affected region. The storage of such information may be used by subsequent image processing techniques to compensate for the defects. Information may be stored in the associated tags to make the compensation routines more robust and the detection more adaptive.

Other aspects of the invention may be found from the attached drawings and other related materials such as a detailed review of the various functions offered by the present invention, which are integral parts of this disclosure. Moreover, other embodiments of the invention will be apparent to those skilled in the art from consideration of the specification and practice of the invention disclosed herein. It is intended that the specification and examples be considered as exemplary only.

1. A method for automatically detecting defects in an image scanning device, comprising the steps of:
performing a defect calibration scan of an image scanning area;
analyzing data produced from the defect calibration scan to detect at least one defect in at least one section of the image scanning area; and
generating a tag for each section of the image scanning area having a detected defect.

2. The method of claim 1, wherein the defect calibration scan data is performed on the occurrence of at least one of the group of events comprising when the image scanning device is powered up, upon request by a user, and periodically.

3. The method of claim 1, further comprising storing the tag.

4. The method of claim 3, further comprising repeating the steps of performing the defect calibration scanning, analyzing defect calibration scan data to detect for a new defect and a change in any previously detected defect, generating and storing a tag for each new detected defect, and updating the stored tag for each previously detected defect that has changed.

5. The method of claim 1, further comprising automatically compensating for the defect based on information contained within the tag.

6. The method of claim 1, further comprising determining the nature of the defect by recursively dividing the section of the image scanning area tagged as having a defect into subareas and analyzing each subarea in detail.

7. The method of claim 1, further comprising determining whether the section of the image scanning area tagged as having a defect is included in a target image region.

8. The method of claim 7, further comprising ignoring the section of the image scanning area tagged as having a defect if that section is determined not to be included in the target image region.

9. The method of claim 8, wherein the section of the image scanning area tagged as having a defect is ignored in autofitting the target image to the image scanning area.

10. The method of claim 8, wherein the section of the image scanning area tagged as having a defect is ignored in cloning the target image to produce multiple target images over the image scanning area.

11. The method of claim 8, wherein the section of the image scanning area tagged as having a defect is ignored in enlarging the target image to fit across multiple image scanning areas.

12. The method of claim 7, further comprising smoothing over the section of the image scanning area tagged as having a defect if that section is determined to be included in the target image region.

13. The method of claim 1, wherein the defect calibration scan is a low resolution scan.

14. An apparatus for automatically detecting defects in an image scanning device, comprsing:
an analyzer for analyzing data produced from a defect calibration scan of an image scanning area by the image scanning device to detect at least one defect in at least one section of the image scanning area; and
a tag generator for generating a tag for each section of the image scanning area in which the defect is detected.

15. The apparatus of claim 14, wherein the defect calibration scan data is performed on the occurrence of one of the group of events comprising when the image scanning device is powered up, upon request by a user, and periodically.

16. The apparatus of claim 14, further comprising a memory for storing the tag.

17. The apparatus of claim 16, wherein the defect calibration scan is repeatedly produced, the analyzer for each repeated scan analyses the calibration scan data to detects a new defect and to detect a change in any previously detected defect, and the tag generator generates a tag for each new defect and updates the tag for each previously detected defect that has changed, and wherein the new tags and updated tags are stored in the memory.

18. The apparatus of claim 14, further comprising a compensator for compensating for the defect based on information contained within the tag.

19. The apparatus of claim 14, further comprising means for determining the nature of the defect by recursively dividing the section of the image scanning area tagged as having a defect into subareas and analyzing each subarea in detail.

20. The apparatus of claim 14, further comprising means for determining whether the section of the image scanning area tagged as having a defect is included in a target image region.

21. The apparatus of claim 20, further comprising means for ignoring the section of the image scanning area tagged as having a defect if that section is determined not to be included in the target image region.

22. The apparatus of claim 21, wherein the section of the image scanning area tagged as having a defect is ignored in autofitting the target image to the image scanning area.

23. The apparatus of claim 21, wherein the section of the image scanning area tagged as having a defect is ignored in cloning the target image to produce multiple target images over the image scanning area.

24. The apparatus of claim 21, wherein the section of the image scanning area tagged as having a defect is ignored in enlarging the target image to fit across multiple image scanning areas.

25. The apparatus of claim 20, further comprising means for smoothing over the section of the image scanning area tagged as having a defect if that section is determined to be included in the target image region.

26. The apparatus of claim 14, wherein the defect calibration scan is a low resolution scan.

27. The apparatus of claim 14, wherein the analyzer and the tag generator are included in the image scanning device.

28. The apparatus of claim 16, wherein the memory is included in the image scanning device.

29. The apparatus of claim 18, wherein the compensator is included in the image scanning device.

30. The apparatus of claim 14, wherein at least one of the analyzer and the tag generator are included in a host computer connected to the image scanning device.

31. The apparatus of claim 16, wherein the memory is included in a host computer connected to the image scanning device.

32. The apparatus of claim 18, wherein the compensator is included in a host computer connected to the image scanning device.
